(19) United States
(12) Patent Application Publication
(10) Pub. No.: US 2003/0048634 A1
(43) Pub. Date: Mar. 13, 2003

(54) LED in-pavement light

(75) Inventors: Chenhua You, Manasquan, NJ (US); Maria E. Saavedra, South Amboy, NJ (US)

Correspondence Address: OBLON, SPIVAK, MCCLELLAND, MAIER & NEUSTADT, P.C., 1940 DUKE STREET, ALEXANDRIA, VA, 22314, US

(73) Assignee: DIALIGHT CORPORATION, FARMINGDALE, NJ

(21) Appl. No.: 09/950,780

(22) Filed: Sep. 13, 2001

(51) Int. Cl. E01F 9/016; F21V 5/02; F21V 31/00

(52) U.S. Cl. 362/153.1; 362/267; 362/244; 362/240; 362/326

(57) ABSTRACT

An in-pavement light that utilizes LEDs as its light source and that utilizes appropriate optics to properly direct light from the LED light source. Specifically, the in-pavement light includes a housing configured to be mounted at least partly below a ground level. An LED light source is housed in the housing. Optics, such as prisms, are configured to direct light from the LED light source such that at least part of the light is directed in a direction substantially parallel to a plane of the ground level.

### BACKGROUND OF THE INVENTION

1. Field of the Invention

The present invention is directed to an in-pavement light such as can be used in an airport runway and taxiway, which utilizes a light-emitting diode (LED) light source.

2. Discussion of the Background

In-pavement lights find common use in airport runways and taxiways. Such in-pavement lights are formed below a pavement surface but project light upwards from below the pavement surface. Conventional in-pavement lights utilize incandescent light bulbs, such as quartz halogen bulbs, as light sources. However, the applicants of the present invention have recognized that the use of incandescent light bulbs in conventional in-pavement lights results in several drawbacks.

First, incandescent light bulbs usually output light of broadband white color so that an in-pavement light utilizing an incandescent light bulb may require an optical filter to cut off light of unwanted colors to obtain a desired color output. Conventional in-pavement lamps utilizing incandescent light bulbs also consume relatively high amounts of power.

Further, since the color temperature changes, incandescent light bulbs currently utilized in in-pavement lights usually suffer from a noticeable color change when applied with different input currents.

Further, the lifetime of incandescent light bulbs is usually only about a few thousand hours. Therefore, utilizing incandescent light bulbs in an in-pavement light requires a significant amount of time and effort to be spent in replacement of the incandescent light bulbs.

### OBJECTS OF THE INVENTION

Accordingly, one object of the present invention is to provide a novel in-pavement light which overcomes the above-noted and other drawbacks recognized by the inventors of the present application.

A further and more specific object of the present invention is to provide a novel in-pavement light that is simple in design.

A further and more specific object of the present invention is to provide a novel in-pavement light that reduces power consumption.

A further and more specific object of the present invention is to provide a novel in-pavement light that is reliable and which can reduce maintenance costs associated therewith.

### SUMMARY OF THE INVENTION

The present invention achieves the above and other objects by setting forth a novel in-pavement light that utilizes LEDs as its light source, and that utilizes appropriate optics to properly direct light from the LED light source.

In one specific structure for achieving the above and other objects in the present invention, the novel in-pavement light of the present invention includes a housing configured to mount at least partly below a ground level, an LED light source housed in the housing, and first optics, which can take the form of optical prisms, configured to direct light from the LED light source, and such that at least part of the light is directed in a direction substantially parallel to a plane of the ground level.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1(a) shows the in-pavement light of the present invention in a finished form;

FIG. 1(b) shows the in-pavement light of the present invention in an expanded form;

FIG. 2(a) shows an embodiment of a light source and optical element structure in one embodiment of the in-pavement light of the present invention;

FIG. 2(b) shows specifics of an optical element of FIG. 2(a) in the in-pavement light of the present invention;

FIG. 3 shows a further embodiment of a light source and optical element structure of the in-pavement light of the present invention;

FIG. 4 shows a further embodiment of a light source and optical element structure of the in-pavement light of the present invention; and

FIG. 5 shows a further embodiment of a light source and optical element structure of the in-pavement light of the present invention.

### DESCRIPTION OF THE PREFERRED EMBODIMENTS

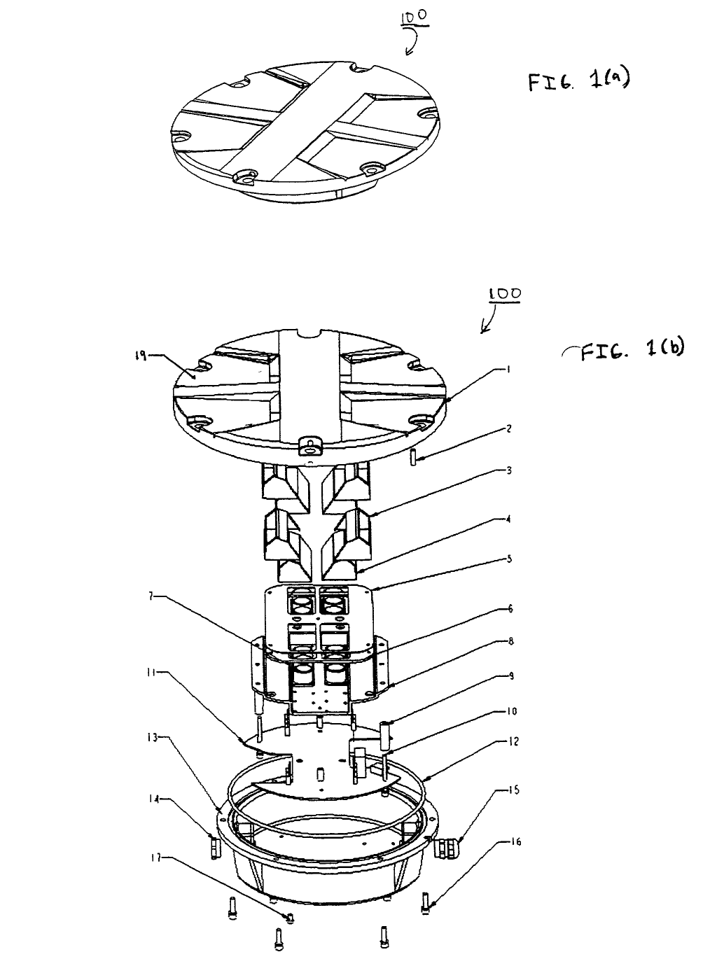

Referring now to the drawings, wherein like reference numerals designate identical or corresponding parts throughout the several views, and more particularly to FIGS. 1(a) and 1(b) thereof, the novel in-pavement light 100 of the present invention is shown in further detail, FIG. 1(b) showing an exploded view of the in-pavement light 100 of FIG. (a).

The inventors of the present application have recognized that an in-pavement light utilizing LEDs as its light source can provide significant benefits over conventional in-pavement lights utilizing incandescent light bulbs as a light source.

The solid state light source of an LED can emit substantially monochromatic light as well as white light in a highly energy efficient and reliable manner. Therefore, an in-pavement light utilizing LED light sources can be simplified by not requiring optical filters to cut off unwanted color lights. Further, LEDs have significantly longer lifetimes compared with incandescent lamps, on the order of 5 to 10 times longer, and thus reliability and maintenance costs can be significantly reduced in an LED based in-pavement light.

For in-pavement lights to meet FAA style III requirements a total height above a finished grade should be equal to or less than 0.25 inches, which can also be achieved in the in-pavement light 100 of the present invention.

As shown in further detail in FIGS. 1(a) and 1(b), the in-pavement light 100 of the present invention includes a top plate 1. The top plate 1 can be a cast circular disk of a matte finish formed of, as examples, zinc-aluminum 12 alloy, zinc-aluminum 27 alloy, aluminum 520, etc. The top plate 1 can be finished with a protective coating against salt, corrosion, and avionics' chemicals. When zinc-aluminum 12 alloy is utilized to form the top plate 1, although it is slightly denser and heavier than the other choices noted above, it can provide a higher yield strength needed to resist harsh airline runway environments. Zinc-aluminum 27 alloy can be used when pressure casting of the top plate 1 is used in manufacturing, and aluminum 520 can be used when a less harsh airline environment is acceptable and cost is a constraining selection criteria.

The top plate 1 provides main support for the housing to mount onto existing runway canisters. The top plate 1 also harnesses electrical, optical, and mechanical subassemblies of the in-pavement light 100. The top plate 100 in conjunction with a bottom housing 13 form a housing for the in-pavement light 100.

The top plate 1 includes grooves 19 on a top thereof from which light is output to illuminate a runway, e.g.

A locating dowel pin 2 can also be provided, such as made from stainless steel or aluminum, to be inserted into the top plate 1 to align the top plate 1 to the bottom housing 13.

A boot gasket structure 3, including four individual boot gasket elements, as an example, can also be provided to be inserted into the top plate 1. The boot gasket elements 3 can, as one example, be made of a molded silicon rubber which can withstand moisture, chemicals, and extreme temperatures and that is also ideal for low maintenance usage. The boot gasket elements 3 are provided to protect optical prism elements 4 as discussed below, provide moisture resistance, and to cushion the prisms 4 against any compression used to hold the prisms 4 in place.

Inserted into the boot gasket elements 3 as noted above are optical prism elements 4 that are provided to properly direct light output from LED light sources 7 to an outside of the in-pavement light 100, as discussed further below.

Provided below the boot gasket elements 3 and prisms 4 is a support gasket 5 that can, as one example, be made of a thin silicon rubber and that can be stamped to produce a custom shape fitted to cover the support plate. That support gasket 5 provides a cushion between the prisms 4 and a support plate 6 provided below the support gasket 5.

The support plate 6 is a plate made, as an example, of an anodized aluminum sheet that can be machined into a custom shape designed to fit the housing. The support plate 6 provides support in upward compression for sealing the prisms 4 to the top plate 1. That force compression creates a wedged interference between the prisms 4 and the top plate 1 cavities to prevent water intrusion to the interior of the in-pavement light 100 through light openings.

A heat sink 8 on which LED elements 7 are mounted is further provided below the support plate 6. The LEDs 7 provide the illumination for the in-pavement light 100. The heat sink 8 may be, as one example, an aluminum stamped and machined sheet metal component chemically treated to resist moisture and corrosion. The heat sink 8 provides the functions of abutting against and precisely aligning the LEDs 7 to direct light to the prisms 4, dissipating excess heat from the LEDs 7 and power board components, and providing a mounting surface to support a power board 11.

The power board 11 is provided below the heat sink 8. The power board 11 is a printed circuit board that can be stamped to size to accommodate the necessary electrical components for the in-pavement light 100. The power board 11 distributes power to the LEDs 7. The LEDs 7 can be provided in many different lighting patterns on the heat sink 8, such as formed on one side of the heat sink 8, formed on both sides simultaneously of the heat sink 8, etc.

The power board 11 is secured to the heat sink 8 by spacers 9 and screws 10. The spacers 9, which can be made of stainless steel or anodized aluminum, are provided to accurately locate and maintain proper distance between the power board 11 and the heat sink 8. The screws 10 can be machined style stainless steel screws with lock washers and can tightly secure the power board 11 to the heat sink 8.

An O-ring 12 is provided and mounted on a top flange of the bottom housing 13 where an O-ring groove can be provided when assembled. The O-ring 12 can be formed, as one example, of extruded silicon rubber and have a ⅛″ cross-section diameter. The O-ring 12 provides a water tight seal between the top plate 1 and the bottom housing 13.

The bottom housing 13 may be formed of a cast and/or machined aluminum component chemically coated to resist moisture and corrosion. The bottom housing 13 provides enclosure to the interior components of the in-pavement light 100 and is to be positioned below a ground, e.g. pavement, level. With the use of the O-ring 12 a tight seal can be maintained. The bottom housing 13 should be structured to accommodate existing runway canister sizes when utilized as an in-pavement light.

Also, either plugs 14 and/or strain release 15 can be provided on an outside of the bottom housing 13. Plugs 14 may be formed of stainless steel and used to seal any optional mounting holes formed in the bottom of the bottom housing 13, for example when using a single power design. An extra coat of silicon seal can be applied to the plugs 14 to maintain the seal integrity. When a dual power design is needed the strain relief 15, which can also be formed of stainless steel, can be used. The strain relief 15, which can be formed of stainless steel and include a power cord compression boot, provides a water-tight seal and guards a power cord line from pulling out of the bottom housing 13.

Compression screws 16 with lock washers and a pressure plug 17 can also be provided for securing purposes. The compression screws 16 with lock washers can be machine-style stainless steel screws and lock washers with a sufficient height to mount the bottom housing 13 to the top plate 1. The compression screws 16 provide the compression necessary to maintain a corrosive and water-tight seal between the bottom housing 13 and the top plate 1. The pressure plug 17 can be formed of, as one example, stainless steel and provides an access point to an air pressure test for the in-pavement light 100 for water intrusion during a manufacturing process. An extra coat of silicon steel can be applied to the pressure plug 17 to maintain its seal integrity.

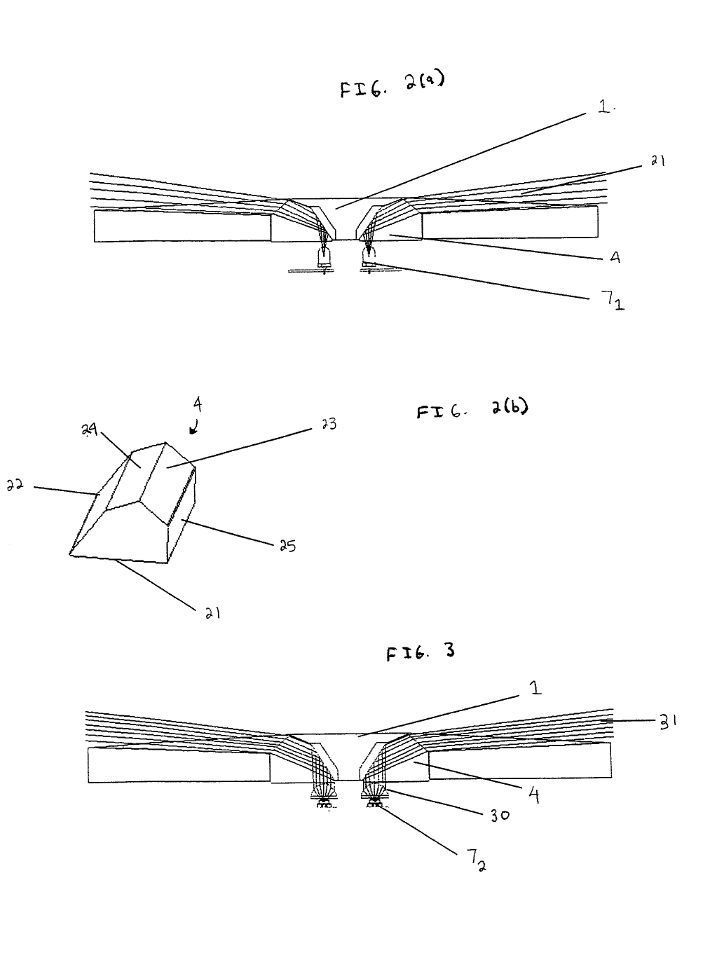

FIG. 2(a) shows specifics of the relation between the LEDs 7 and prism 4 in one specific embodiment of the present invention. In the specific embodiment of FIG. 2(a) the LEDs 7 may be specific 5 mm narrow view angle LEDs 7₁, which have viewing angles of 10°. The narrow view angle LEDs 7₁ are mounted in a direction so that the optical axes of the LEDs 7₁ are perpendicular to the finished grade of the in-pavement light 100.

FIG. 2(b) shows the prism 4 in further detail. As shown in FIG. 2(b) the prism 4 includes an entry surface 21, a reflective surface 22, an exit surface 23, and mounting surfaces 24 and 25.

As shown in FIG. 2(a) output light rays 21 from the LEDs 7₁ enter the entry surface 21 of the prism 4, undergo a total internal reflection off the reflective surface 22 of the prism 4, and exit from the exit surface 23 of the prism 4. The slope of the exit surface may range from 15° to 40°, in one preferred embodiment. If the slope is less than 15° large Fresnel losses on the surface may be introduced. The slope of the reflective surface 22 preferably ranges from 54° to 64° so that the light beam 21 exiting from the prism 4 covers a substantially vertical range of from 0° to 15°.

With the structure of the in-pavement light 100 of the present invention, light rays 21 are output at an angle which is substantially parallel to the ground level, and in this context the term “substantially parallel” means from 0° to 15°, as noted above.

The prism 4 may be formed of a chemically treated tempered glass but other high impact scratch resistant transparent optical materials can also be used.

Different types of LEDs 7 than narrow viewing angle ones 7₁ as shown in FIGS. 2(a) and 2(b) can also be utilized in the present invention.

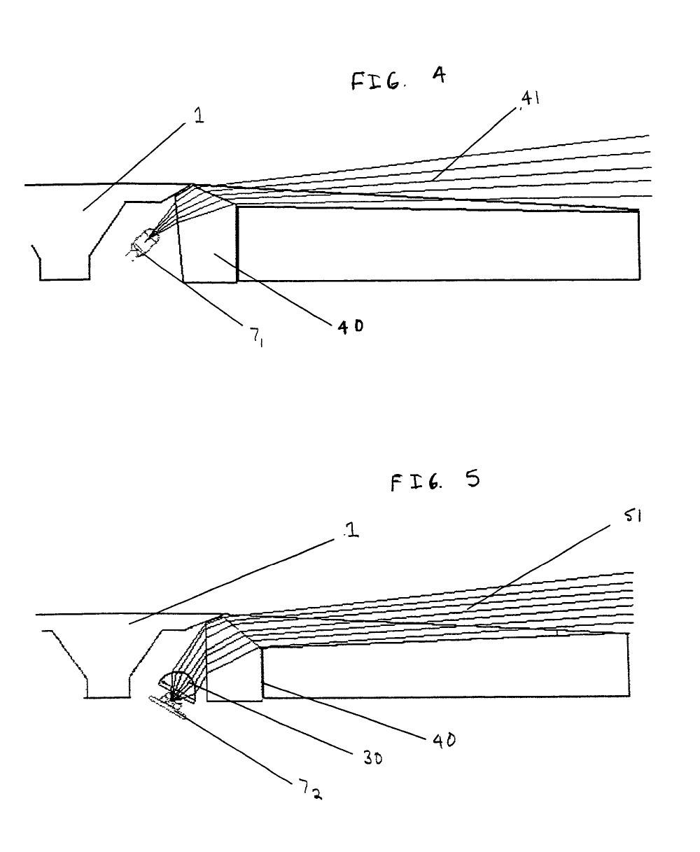

In the embodiment of FIG. 3 LEDs 7₂ with a large viewing angle, such as surface mounted LEDs and Lumileds Luxeon™ LEDs, may be utilized. In that design the divergent angle of the LED light output 31 may be too large for a spatial distribution requirement. As a result, secondary optics 30 placed at an output of the LEDs 7₂ can be utilized to reduce the beam angle. In that case the output light beam 31 emitted from the LEDs 7₂ passes first through the secondary optics 30 to reduce their divergent angle prior to being input to the entry face 21 of the prism 4.

The secondary optics 30 may take the form of a simple positive lens as shown in FIG. 3, or of a combined refractive and reflective optics or collimating optics. The secondary optics may be made of acrylic with injection mode technique, but other optical materials may also be utilized to form the secondary optics 30.

FIG. 4 shows a further embodiment of the present invention in which a different prism structure is utilized. In FIG. 4 the prism 40 utilized is a refractive prism. In that embodiment the narrow view angle LEDs 7₁ are mounted at an angle to the finished grade of the refractive prism 40. As an example the LEDs 7₁ may be mounted on a surface 44° to the finished grade, and the prism 40 may have two refractive surfaces at 109° and 20° respectively. That provides an appropriate output of the light beams 41 to again cover a vertical range from 0° to 15° substantially parallel to the ground or pavement level.

In a further embodiment as shown in FIG. 5 a similar prism 40 as used in FIG. 4 is utilized but high flux LEDs 7₂, as in the embodiment of FIG. 3, with a large viewing angle are utilized, so again the secondary optics 30 are employed. The embodiment of FIG. 5 then operates similarly to the embodiment of FIG. 4.

The above-noted various structures of the novel LED in-pavement lights of the present invention provide the significant advantages as noted above of outputting monochromatic and white light, and thereby not needing optical filters, being energy efficient, having a long lifetime, being very reliable, and having low maintenance requirements.

Obviously, numerous additional modifications and variations of the present invention are possible in light of the above teachings. It is therefore to be understood that within the scope of the appended claims, the present invention may be practiced otherwise than as specifically described herein.

1. An in-pavement light comprising:
(a) a housing configured to be mounted at least partly below a ground level;
(b) an LED light source housed in said housing;
(c) first optics configured to direct light from said LED light source, at least part of the light being directed in a direction substantially parallel to a plane of the ground level.

2. An in-pavement light according to claim 1, wherein said first optics comprises at least one prism element.

3. An in-pavement light according to claim 1, further comprising (d) second optics positioned between said LED light source and said first optics and configured to reduce a divergent angle of the light output from said LED light source.

4. An in-pavement light according to claim 2, further comprising (d) second optics positioned between said LED light source and said first optics and configured to reduce a divergent angle of the light output from said LED light source.

5. An in-pavement light according to claim 1, wherein said first optics directs the part of the light substantially parallel to the plane of the ground level at a range from 1° to 15° with respect to the ground level.

6. An in-pavement light according to claim 1, wherein said housing (a) comprises:
(a1) a base housing; and (a2) a top plate secured to the base housing.

7. An in-pavement light according to claim 6, further comprising (d) an O-ring positioned between said base housing and said top plate.

8. An in-pavement light according to claim 1, further comprising (d) a gasket structure configured to hold said first optics and to position said first optics to receive light from said LED light source. from said LED light source.

9. An in-pavement light according to claim 2, further comprising (d) a gasket structure configured to hold said first optics and to position said first optics to receive light from said LED light source.

10. An in-pavement light according to claim 3, further comprising (d) a gasket structure configured to hold said first optics and to position said first optics to receive light from said LED light source.

11. An in-pavement light comprising:
(a) housing means for mounting at least partly below a ground level;
(b) LED light means housed in said housing means;
(c) first optics means for directing light from said LED light means, at least part of the light being directed in a direction substantially parallel to a plane of the ground level.

12. An in-pavement light according to claim 11, wherein said first optics means comprises at least one prism means.

13. An in-pavement light according to claim 11, further comprising (d) second optics means positioned between said LED light means and said first optics means for reducing a divergent angle of the light output from said LED light means.

14. An in-pavement light according to claim 12, further comprising (d) second optics means positioned between said LED light means and said first optics means for reducing a divergent angle of the light output from said LED light means.

15. An in-pavement light according to claim 11, wherein said first optics means directs the part of the light substantially parallel to the plane of the ground level at a range from 1° to 15° with respect to the ground level.

16. An in-pavement light according to claim 11, wherein said housing means (a) comprises: (a1) base housing means; and (a2) top base means secured to the base housing means.

17. An in-pavement light according to claim 16, further comprising (d) sealing means positioned between said base housing means and said top base means.

18. An in-pavement light according to claim 11, further comprising (d) means for holding said first optics means and for positioning said first optics means to receive light from said LED light means.

19. An in-pavement light according to claim 12, further comprising (d) means for holding said first optics means and for positioning said first optics means to receive light from said LED light means.

20. An in-pavement light according to claim 13, further comprising (d) means for holding said first optics means and for positioning said first optics means to receive light from said LED light means.
